(19) United States
(12) Patent Application Publication
(10) Pub. No.: US 2004/0026879 A1
(43) Pub. Date: Feb. 12, 2004

(54) Method for controlling a level control system

(76) Inventors: Harald Schaumburg, Sarstedt (DE); Alexander Stiller, Garbsen (DE)

Correspondence Address: Walter Ottesen, Patent Attorney, P.O. Box 4026, Gaithersburg, MD, 20885-4026, US

(21) Appl. No.: 10/456,499

(22) Filed: Jun. 9, 2003

(30) Foreign Application Priority Data
Jun. 11, 2002 (DE) 102 25 940.2

(51) Int. Cl. B60G 17/01

(52) U.S. Cl. 280/5.5

(57) ABSTRACT

A method controls a level control system in a motor vehicle and the system includes elevation sensors for measuring the distance between the body of the motor vehicle and corresponding axles of the motor vehicle. The level control system controls this distance to a desired level. The method provides for determining the direction of travel of the motor vehicle and correcting the measurement signal of the elevation sensors in a direction toward the desired level when there is a rearward travel of the motor vehicle.

### FIELD OF THE INVENTION

The invention relates to a method for controlling a level control system with which the distance of a vehicle body of a motor vehicle to at least one axle of the motor vehicle is controlled to a desired level with the aid of at least one elevation sensor which measures the distance between the vehicle body and the vehicle axle.

### BACKGROUND OF THE INVENTION

Vehicle control systems with which the distance of the vehicle body of a motor vehicle to at least one axle of the motor vehicle is controlled are known for some time and are built into modern motor vehicles especially in the form of air spring systems. In transport vehicles, often only the level of the rear axle is controlled with the aid of the air spring system; whereas, and especially in sport utility vehicles, the level of both axles of the motor vehicle is controlled with the aid the level control system.

Especially at higher vehicle speeds, it can happen in modern motor vehicles (for example, because of their aerodynamics) that the body of the motor vehicle is lowered or raised so that the center of gravity (in the case of a reduction of elevation) of the motor vehicle is displaced downwardly and a better road support is imparted to the vehicle. In such a state of the motor vehicle, the elevation sensors of the level control system measure a distance of the vehicle body to the axles which distance lies below the desired level. At high vehicle speeds, the measurement signal of the elevation sensors is corrected so that this signal corresponds to the measurement signal of the desired level so that the level control system does not control the level position to the desired position at high vehicle speeds. In this way, the situation is achieved that the above-described reduction of the center of gravity of the vehicle is maintained.

In addition, positive or negative accelerations operate on the motor vehicle in specific driving situations and these accelerations can lead to the situation that the vehicle body is raised in the region of the forward axle and is lowered in the region of the rear axle (for positive acceleration) or vice versa for negative accelerations. If a level control system would control the desired level for such an alignment of the vehicle body, then this would lead, for a positive acceleration, to the situation that a vehicle body would be lowered in the region of the forward axle and would be raised in the region of the rearward axle (for a negative acceleration the same would take place in reverse). After the termination of the (positive) acceleration operation, which mostly takes place only over a short time, this would lead to the situation that the vehicle body would lie below the desired level in the region of the forward axle and would lie above the desired level in the region of the rearward axle. For this reason, a renewed control would be necessary directly after terminating the acceleration operation. In modern level control systems, the measured values, which are measured by the elevation sensors, are correspondingly adapted during the acceleration operations of the motor vehicle in order to prevent the above-mentioned unwanted adaptation of the motor vehicle to the desired level during the acceleration. In a positive acceleration of the motor vehicle, the value of the elevation sensor, which is measured at the forward axle, is therefore corrected downwardly and the value of the elevation sensor measured at the rearward axle is correspondingly corrected upwardly (the conditions are opposite for a negative acceleration). In this way, unnecessary control operations can be avoided.

In contrast, for a rearward travel of the motor vehicle, the conditions are different. If, for example, in a rearward travel of the motor vehicle a positive acceleration takes place, then this leads to the situation that the vehicle body of the motor vehicle drops below the desired level in the region of the forward axle; whereas, the vehicle body is raised above the desired level in the region of the rearward axle. This is also registered by the elevation sensors in the region of the axles. If the elevation signals of the measuring sensors are now corrected in the manner described above for positive accelerations, then this would lead to the situation that the measurement signal for the forward axle is further reduced whereas, the measurement signal for the rearward axle is further increased. The level control system would thereupon greatly raise the vehicle body in the region of the forward axle during the acceleration operation and greatly lower the vehicle body in the region of the rearward axle. After the completion of the positive acceleration operation, this leads to the situation that the vehicle body is clearly above the desired level in the region of the forward axle; whereas, the vehicle body is clearly below the desired level in the region of the rearward axle. After completion of the acceleration operation (mostly short), a large correction of the level of the vehicle body in the region of both axles is again necessary. In this way, often unnecessary control operations take place during the rearward travel of modern motor vehicles.

### SUMMARY OF THE INVENTION

It is an object of the invention to provide a method for controlling a level control system so that it is substantially ensured even for a rearward travel of the motor vehicle that no unnecessary control operations take place in the level control system.

The method of the invention is for controlling a level control system in a motor vehicle and the system includes elevation sensors for measuring the distance between the body of the motor vehicle and corresponding axles of the motor vehicle, the level control system controlling the distance to a desired level. The method includes the steps of: determining the direction of travel of the motor vehicle; and, correcting the measurement signal of the elevation sensors in a direction toward the desired level when there is a rearward travel of the motor vehicle.

The advantage achieved with the invention is especially that even for a rearward travel of the motor vehicle, unnecessary control operations of the level control system no longer occur. In this way, during forward travel as well as during rearward travel of the motor vehicle, unnecessary control operations are prevented in the level control system. If, for example, because of rearward travel at a relatively high speed, there occurs a raising of the vehicle body because of the aerodynamic of the motor vehicle, then the measurement signal of each elevation sensor in the level control system is corrected in the direction of the desired level (that is, the instantaneous measurement signal of each elevation sensor is adapted in the direction of the measurement signal of each elevation sensor, which this sensor would indicate in the desired level (in the above-mentioned example, therefore lowered).

According to another feature of the invention, the correction of the measurement signal of each elevation sensor is undertaken in dependence upon the speed of the motor vehicle. The advantage achieved with this embodiment is that unnecessary control operations in the level control system, which are caused by a constant speed of the vehicle, are avoided.

According to another feature of the invention, the acceleration of the motor vehicle is measured and the correction of the measurement signals of each elevation sensor is undertaken in dependence upon the acceleration of the motor vehicle. The advantage of this embodiment is that, for a rearward travel of the motor vehicle, unnecessary control operations within the level control system are for the most part suppressed. These control operations are caused by a positive or negative acceleration of the motor vehicle. This method of the invention can be carried out alternatively to the previous method (in this case, exclusively the unnecessary control operations are suppressed which are caused by an acceleration of the motor vehicle) or in addition to the above feature (in this case, unnecessary control operations which are caused by speed or acceleration are substantially suppressed within the level control system).

According to another feature of the invention, a table is stored in the central unit of the level control system wherein corrective values for the measurement signals of each elevation sensor are stored corresponding to specific rearwardly directed speeds and/or for specific accelerations. The advantage of this embodiment is that the corrective values for the measurement signals can be taken from the tables in a simple manner and are then available without complex computation operations so that the needed corrections can be made without unnecessary time delays. Preferably, the corrective values are already stored in the table during manufacture of the motor vehicle.

The corrective values are determined preferably for an average loading of the motor vehicle. If the loading of the motor vehicle later deviates during the travel from the average loading (for example, because of a heavy additional load), then this leads to the situation that the level control system compensates the deviation from the desired level, which occurs because of the deviating load, by a control. The control, which is undertaken because of the deviating loading, is also undertaken, for example, during a rearward travel and a great positive acceleration because the corrective values, which are taken from the table for the case, are related to the average loading as explained hereinafter.

According to another feature of the invention and for those speeds and accelerations not contained in the table, the corrective value is determined by linear interpolation between those corrective values which are assigned to the speeds or acceleration between which the instantaneous speed or acceleration lies. The advantage of this feature of the invention is that corrective values can be determined in a short time also for those speeds or accelerations which are not stored and this can be done in a simple manner and without a great complexity as to computation.

According to still another feature of the invention, the travel direction of the motor vehicle is determined based on the transmission position of the vehicle transmission. If the transmission is in the rearward gear, then a conclusion can be drawn that the vehicle is moving in reverse if it is not at standstill. If, in contrast, the transmission is in one of the forward gears, then it can be correspondingly concluded that the vehicle is moving forward if not in standstill. A corresponding signal is transmitted via a CAN-bus to the central unit of the level control system so that a corresponding signal is present there. The advantage of this feature is that the driving direction of the motor vehicle can be determined in a simple manner.

According to another feature of the invention, the acceleration of the motor vehicle is determined in that, at two time points, the difference quotient is determined from the speeds (at these time points) and the time points. The advantage of this feature is that the acceleration of the motor vehicle can be determined with the aid of the difference quotient in a simple manner.

According to another feature of the invention, the measurement signals of the elevation sensors are corrected to the desired level. Here too, the corrective values, which lead to a correction of the measurement signals to the desired level, are preferably referred to an average loading of the motor vehicle. The advantage of this embodiment is that, in the level control system during the entire (accelerated) rearward travel, the “impression” arises that the vehicle body is at the desired level and therefore no unnecessary control operations are undertaken in the level control system which are caused by the condition of the motor vehicle. If, in contrast, the laden state of the motor vehicle deviates from the average laden state (to which the corrective values apply), then a deviation of the level (which results because of the deviating laden state) is compensated via a control by the level control system.

According to another feature of the invention, a measurement and correction of the measurement signals of each elevation sensor is undertaken continuously or at time intervals. These time intervals lie between 0.01 and 10 seconds and are preferably between 0.01 and 1 second. The advantage of this embodiment is that a correction of the measurement signals is not made time displaced from the instantaneous driving state of the vehicle so that no incorrect control can take place within the level control system because of such an unwanted time displacement.

### BRIEF DESCRIPTION OF THE DRAWINGS

The invention will now be described with reference to the drawings wherein:

FIG. 1 is a schematic of a level control system according to an embodiment of the invention; and,

FIG. 2 is a table stored in the central unit of the level control system.

### DESCRIPTION OF THE PREFERRED EMBODIMENTS OF THE INVENTION

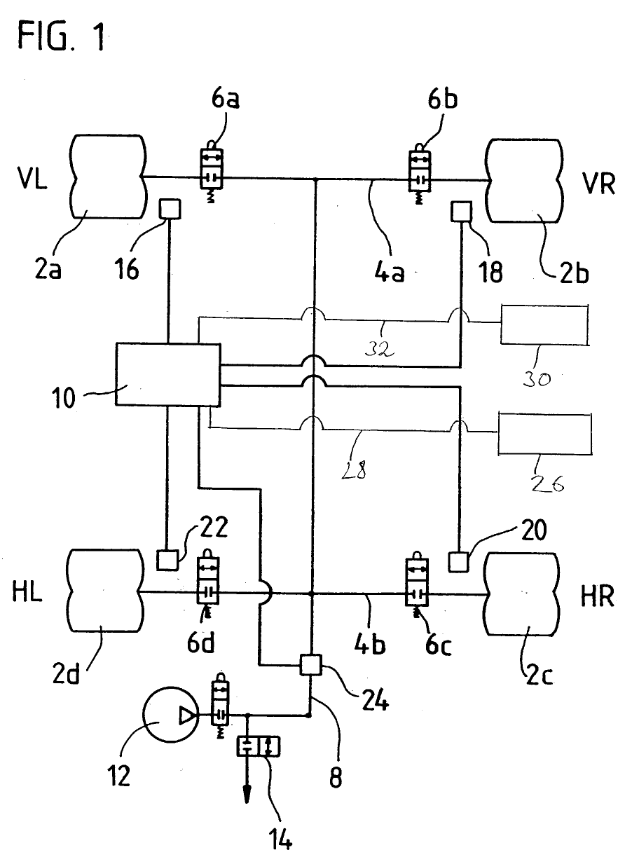

FIG. 1 is a schematic of a level control system in the form of an air spring system for a motor vehicle. The air spring system includes air springs (2a, 2b) which are assigned to the forward axle of the motor vehicle and includes air springs (2c, 2d) which are assigned to the rear axle of the motor vehicle. With the air springs 2a to 2d, a vehicle body of the motor vehicle is suspended relative to the axles. The air springs (2a, 2b) are connected to each other via a transverse line 4a and the air springs (2c, 2d) are connected to each other via a transverse line 4b. Each transverse line (4a, 4b) contains two transverse check valves (6a, 6b) and (6c, 6d) of which each is assigned to a corresponding air spring 2a to 2d. Furthermore, the transverse lines (4a, 4b) are connected to a further line 8 via which the air springs 2a to 2d are filled with pressurized air with the aid of the compressor 12 or compressed air is released to the atmosphere via the line from the air springs 2a to 2d. For this purpose, the control inputs of the corresponding valves 6a to 6d, discharge valve 14 and the compressor 12 are driven by the central unit 10 of the air spring system. With the level control system shown in FIG. 1, the desired level of the vehicle body can be maintained independently of the laden state of the motor vehicle as known per se.

In addition to the above-mentioned components, the motor vehicle includes a schematically represented transmission 26 from which a signal is transmitted to the central unit 10 via a signal line 28 and this signal advises whether the transmission is in the reverse gear or in a forward gear. In addition, the motor vehicle includes a unit 30 with which the speed (v) of the motor vehicle is determined which is transmitted via a signal line 32 likewise to the central unit 10 of the level control system. In this way, it can be determined in the central unit 10 with which speed (v) the motor vehicle is traveling rearwards. In this case, a signal for the reverse gear of the transmission 26 is transmitted to the central unit 10 via the signal line 28 and a specific speed (v) of the motor vehicle, which is unequal to 0, is transmitted via the signal line 32.

Furthermore, the acceleration of the motor vehicle can be determined in the central unit 10 in that the speed v1 is determined at a time point t1 and the speed v2 of the motor vehicle is determined at a later time point t2 and thereupon the difference quotient dv/dt=(v2-v1)/(t2-t1) is formed. The closer the times t2 and t1 lie, the more accurate is the instantaneous acceleration of the motor vehicle determined via the computation of the difference quotients. From the sign of the difference quotient, one can determine whether it is a positive or a negative acceleration. In the first case, v2 is greater than v1 (the difference quotient is therefore positive) and, in the second case, v2 is less than v1 (the difference quotient is therefore negative). The term t2-t1 is always positive because t2 is always greater than t1.

For a rearward travel of the motor vehicle, the instantaneously measured measurement signal of each elevation sensor 16 to 22 is transmitted to the central unit 10 and is corrected in a direction of the desired level in order to avoid unnecessary control operations in the air spring system.

First, it is explained as to how a correction is made which is exclusively dependent upon the speed. If, for example, the speed v1 is transmitted to the central unit 10 by the unit 30, then a corrective value hkv1 is added to the measurement signal hmess of the elevation sensor 16. This corrective value corrects the measurement signal of the elevation sensor in the direction of the desired level. Accordingly, the corrective measurement signal hkorr is as follows:

hkorr=hmess+hkv1 . (1)

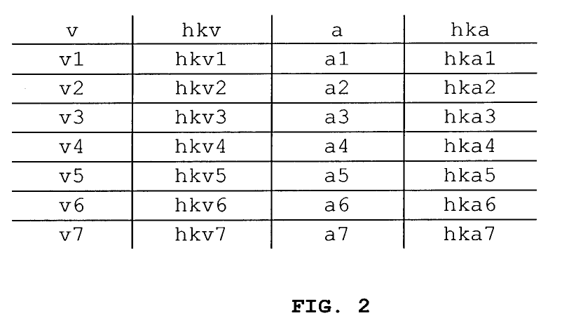

The corrective value hkv1 is taken from a table which is stored in the central unit 10 and is shown schematically in FIG. 2. The corrective value hkv1 is preferably so fixed in the calibration of the table that the corrected measurement signal hkorr, which is computed in accordance with the above formula, corresponds to the measurement signal which would be indicated by the elevation sensor 16 when the motor vehicle has an average laden state and is in the desired level. This then leads during a rearward travel at a constant speed (v) to the following. If the motor vehicle actually has an average load, then the corrected measurement signal, which is computed in accordance with equation (1), corresponds to the measurement signal which the elevation sensor 16 would indicate at a standstill of the motor vehicle and a control by the air spring system is not undertaken (even though the motor vehicle actually deviates from the desired level because of the rearward travel). Accordingly, if the motor vehicle should have lifted, for example, because of the rearward travel (in this case, the values hkv are negative), then the vehicle body is not lowered during the rearward travel so that a lifting of the chassis body does not have to take place after the conclusion of the rearward travel. In this way, unnecessary control operations in the air spring system are suppressed. The same applies when the vehicle body drops during the rearward travel. In the same way the procedure would be the same for the other elevation sensors 16 to 22 in the central unit 10, that is, a table as shown in FIG. 2 is stored for each elevation sensor.

If the laden state of the motor vehicle deviates, however, from the average laden state because of a heavy additional loading, then the corrected measurement signal, which is computed according to equation (1), does not correspond to the measurement signal which the elevation sensor 16 would indicate at standstill of the motor vehicle; instead, the corrected measurement signal would lie below this measurement signal because of the laden state of the motor vehicle. In this case, the vehicle body is raised by the air spring system in the region of the elevation sensors 16 and the air spring 2a until the corrected measurement signal hkorr shows the desired level. With this control operation, the deviation from the desired level is compensated which is caused exclusively by the additional loading of the vehicle. One would proceed correspondingly when the motor vehicle is greatly unloaded and for this reason, the laden state deviates from the average laden state.

If a speed v1 is transmitted from the unit 30 (which speed, for example, lies between v1 and v2), then the corrective value hkvi which belongs to this speed, is computed by linear interpolation between the corrective values hkv1 and hkv2. With this linear interpolation, an exact corrective value can be computed with little effort even for a speed lying between the speeds v1 and v2. The same procedure is followed when the transmitted speed lies between the speeds v2 and v3, et cetera.

In the following, it will be explained how, during the rearward travel of the motor vehicle, the measurement signals of each elevation sensor 16 to 22 are corrected in dependence upon the acceleration of the motor vehicle. First, the instantaneous acceleration of the motor vehicle is computed as explained above in the central unit 10. Thereafter, a corrective value hka1 is taken from the table shown in FIG. 2, for example, for the computed acceleration a1 for the elevation sensor 16. The corrected measurement signal hkorr is computed in the central unit as follows:

pi hkorr=hmess+hka1 . (2)

Here too, hka1 is so fixed in the calibration of the table that the computed corrected measurement value hkorr corresponds to the measurement signal which is indicated by the elevation sensor 16 when the motor vehicle has an average laden state and is at the desired level. The same procedure is followed for the elevation sensors 18 to 22. The air spring system is here also controlled based on the computed values hkorr. With this procedure, unnecessary control operations as a consequence of an acceleration of the motor vehicle can be avoided in the air spring system. When the actual laden state of the motor vehicle deviates from the average laden state, then the procedure is followed for an acceleration as already explained above in connection with the speed. In the event that the instantaneous acceleration of the motor vehicle lies between the values set forth in the table of FIG. 2, the corresponding corrective values are determined via linear interpolation as explained above in connection with the speed.

### EXAMPLE

The motor vehicle has an average laden state and travels in reverse with a positive acceleration. In this case, the vehicle body of the motor vehicle drops in the region of the forward axle below the desired level because of the positive acceleration and the vehicle body is lifted above the desired level in the region of the rearward axle. Accordingly, the elevation sensors 16 and 18 have a measurement signal hmess which lies below the desired level and the elevation sensors 20 and 22 exhibit a measurement signal hmess which lies above the desired level. For the elevation sensors 16 and 18, the corrective values hka1, which belong to the positive acceleration a1, are accordingly positive and so fixed in the calibration of the table of FIG. 2 that, for the computation of the corrected measurement signal in accordance with equation (2), a value results which the elevation sensors 16 and 18 would indicate when the motor vehicle is at the desired level. In contrast, for the elevation sensors 20 and 22, negative corrected values hka1 result for the acceleration a1 in this case. These corrective values hka1 are likewise so fixed in the calibration that, for the computation of the corrected measurement signal hkorr according to equation (2), a measurement signal likewise results which the elevation sensors 20 and 22 would indicate when the motor vehicle is at the desired level in the region of the rear axle.

The motor vehicle is controlled based on the corrected measurement signals which for all four elevation sensors 16 to 22 indicate the desired level. Accordingly, a control within the air spring system does not take place during the reverse travel of the motor vehicle with a positive acceleration.

After the conclusion of the positive acceleration (when the motor vehicle is propelled, for example, at constant speed), the air spring system is again normally controlled. If, during the reverse travel with positive acceleration, the vehicle has a laden state which deviates from the average laden state, then only the effects are considered via the corrective values hka which are caused by the acceleration and the deviations from the desired value of the vehicle body (which are attributed to the laden state) are detected by the air spring system and compensated by a corresponding control.

If a negative acceleration is present during reverse travel, then the vehicle body is lifted above the desired level in the region of the forward axle and is lowered below the desired level in the region of the rearward axle so that the above applies in the same way only with correspondingly changed signs (that is, the corrective values hka for the elevation sensors 16 and 18 are negative and the corrective values hka for the elevation sensors 20 and 22 are positive).

If, during the reverse travel of the motor vehicle, the measurement signals are to be corrected in dependence upon the speed of the motor vehicle as well as in dependence upon the acceleration of the motor vehicle, then the individual corrected measurement signals hkorr are computed as follows:

hkorr=hmess+hkvi+hkaj (3)

wherein: hkvi is the corrective value for the instantaneous speed and hkaj is the corrected value for the instantaneous acceleration and these corrective values are taken directly from the table shown in FIG. 2 or, as explained above, are taken via linear interpolation. Here too, the foregoing applies for the laden states which deviate from the average laden state.

The correction of the measurement values is made continuously or at time intervals for each elevation sensor in the elevation control system. These time intervals lie preferably between 0.1 and 10 seconds.

After the end of the reverse travel (when the vehicle is at standstill or travels in the forward direction), the air spring system is again controlled normally. With the method of the invention, raisings or lowerings of a vehicle body are suppressed during reverse travel of a motor vehicle with these raisings and lowerings being attributed to the dynamic of the motor vehicle.

It is understood that the foregoing description is that of the preferred embodiments of the invention and that various changes and modifications may be made thereto without departing from the spirit and scope of the invention as defined in the appended claims.

What is claimed is:

1. A method for controlling a level control system in a motor vehicle and the system including elevation sensors for measuring the distance between the body of the motor vehicle and corresponding axles of the motor vehicle, the level control system controlling said distance to a desired level, the method comprising the steps of:
determining the direction of travel of said motor vehicle; and,
correcting the measurement signal of said elevation sensors in a direction toward said desired level when there is a rearward travel of said motor vehicle.

2. The method of claim 1, comprising the further step of correcting said measurement signals of said elevation sensors in dependence upon the speed of said motor vehicle.

3. The method of claim 1, wherein a first one of said sensors measures the distance between said vehicle body and the forward axle and a second one of said sensors measures the distance between said vehicle body and the rearward axle; said method comprising the further steps of:
measuring the acceleration of said motor vehicle;
if said acceleration is positive, reducing the measurement signal of said second sensor in the direction toward said desired level and, correspondingly, increasing the measurement signal of said first sensor in the direction toward said desired level; and,
if said acceleration is negative, reducing the measurement signal of said first sensor in the direction of said desired level and, correspondingly, increasing the measurement signal of said second sensor in the direction of said desired level.

4. The method of claim 1, wherein said level control system includes a central unit having a table stored therein wherein corrective values for the measurement signals of each of said elevation sensors are stored which are assigned to specific rearward directed speeds and specific accelerations.

5. The method of claim 4, comprising the further step of, for speeds and accelerations not contained in said table, determining the corrective values by linearly interpolating between the corrective values to which speeds or acceleration are assigned between which the instantaneous speeds or accelerations lie.

6. The method of claim 1, comprising the further step of determining the direction of travel of said motor vehicle based on the setting of the transmission.

7. The method of claim 1, comprising the further step of determining the acceleration of said motor vehicle in that, at two time points, the difference quotient is determined from the speed at said two time points and the time points.

8. The method of claim 1, wherein the measurement signal of each elevation sensor is corrected to the desired level.

9. The method of claim 1, comprising the further step of making a measurement and correction continuously of the measurement signal of each of said elevation sensors.

10. The method of claim 1, comprising the further step of making a measurement and correction of the measurement signal of each of said elevation sensors at a time interval.

11. The method of claim 10, wherein said time interval lies between 0.1 and 10 seconds.

12. A level control system for a motor vehicle having a vehicle body and axle, the system comprising:
an elevation sensor for measuring the distance between said vehicle body and said axle;
control means for controlling said distance to a desired value;
said control means including a central unit wherein the direction of travel of said motor vehicle is determined; and,
said central unit including means for correcting the measurement signal of said elevation sensor in a direction toward said desired value when there is a rearward travel of said motor vehicle.
